(19) United States
(12) Patent Application Publication
(10) Pub. No.: US 2007/0138790 A1
(43) Pub. Date: Jun. 21, 2007

(54) Coupling

(75) Inventors: Axel Feger, Lorrach (DE); Michael Trede, Habsheim (FR)

Correspondence Address: BAKER & DANIELS LLP;111 E. WAYNE STREET, SUITE 800, FORT WAYNE, IN, 46802, US

(73) Assignee: A. RAYMOND & CIE, Grenoble (FR)

(21) Appl. No.: 10/596,657

(22) PCT Filed: Nov. 18, 2004
(86) PCT No.: PCT/EP04/13062

§ 371 Date: Jun. 20, 2006

(30) Foreign Application Priority Data
Aug. 11, 2004 (DE) 102004038913.6

(51) Int. Cl. F16L 37/00

(52) U.S. Cl. 285/305

(57) ABSTRACT

A coupling having a receiver (1), for receiving an insert (3) formed with a retaining ring (2), and a locking element (10) having two arms (11, 12) and a retaining portion (14). The locking element (10) fits into a receiving space (7) of the receiver (1) and is movable between a raised and a pushed-in position. A lifting bevel (16) is formed on the locking element (10) and cooperates with the retaining ring (2) of the insert (3) so that the locking element (10) can be moved from the pushed-in position to the raised position. The coupling also comprises a prelock assembly (30) and a pullback assembly (18, 19, 22, 23), which cooperate so that when the retaining ring (2) is moved in the insertion direction into position behind the lifting bevel (16), the prelock assembly (30) engages behind the retaining ring (2) and the pullback assembly (18, 19, 22, 23) shifts the locking element (10) into a prelocked position.

### BACKGROUND OF THE INVENTION

The invention relates to a fluid coupling and in particular to a fluid coupling having an insert and a receiver.

Such a coupling is known from DE 199 46 260 C1. The previously known coupling comprises a receiving part for receiving an insert formed with a retaining ring. A locking element having two arms and a retaining portion is also present, which locking element can be fitted into a receiving space in the receiving part and moved perpendicularly to an insertion direction of the insert between a raised position and a pushed-in position. By this means, when the locking element is in the pushed-in position, the insert is protected against inadvertently slipping out of the receiving part by the engagement of the retaining portion behind the retaining ring. However, it is possible for the locking element to be in the pushed-in position without the insert being properly secured.

The object of the invention is to specify a coupling of the aforesaid kind that is characterized by high assembly reliability.

### SUMMARY OF THE INVENTION

The invention comprises a hollow receiver and an insert for insertion into the receiver. The insert includes a retaining ring. The receiver includes a locking element which has three positions, namely, a pushed-in position, a prelocked position, and a raised position. The locking element has a first beveled surface which cooperates with the retaining ring to move the locking element from a pushed-in position to the raised position when the insert is initially inserted into the receiver. The receiver further includes a prelock assembly and a pullback assembly which are adapted to cooperate with the retaining ring when the insert is inserted further into the receiver, beyond the pushed-in position, after the retaining ring has moved out of contact with the beveled surface. The prelock assembly engages the retaining ring and the pullback assembly moves the locking element into the prelocked position. Upon movement of the locking element into the pushed-in position, the insert is sealingly locked in the receiver.

The fact that in the inventive coupling, when an insert is inserted, the locking element moves from the pushed-in position into the raised position due to cooperation between the lifting bevel and the retaining ring of an insert, and when the insert is properly arranged in the inventive coupling, the locking element is shifted by the pullback assembly into a prelocked position in which the prelock assembly engages behind the retaining ring to keep the insert from shifting the locking element into the pushed-in position, without which measure the insert would be forced back out by the action of the bevel on the retaining ring, thereby shifting the locking element from the raised position into the pushed-in position, makes for reliable assembly, which is very important especially in the case of assembly-line work involving the tightly synchronized connection of inventive couplings to inserts.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a partially cut-away perspective view of an exemplary embodiment of an inventive coupling comprising a receiving part and a locking element, the latter being in a pushed-in position, plus an insert that is to be fitted into the inventive coupling;

FIG. 2 is a partially cut-away perspective view of the exemplary embodiment according to FIG. 1, with an insert inserted into the inventive coupling and the locking element in a prelocked position;

FIG. 3 is a cross section, taken along lines 3-3 of FIG. 2;

FIG. 4 is a partially cut-away perspective view of the exemplary embodiment according to FIG. 1, with an insert inserted into the receiving part and the locking element in a pushed-in position; and

FIG. 5 is a cross section of the exemplary embodiment taken along line 5-5 of FIG. 4.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENT

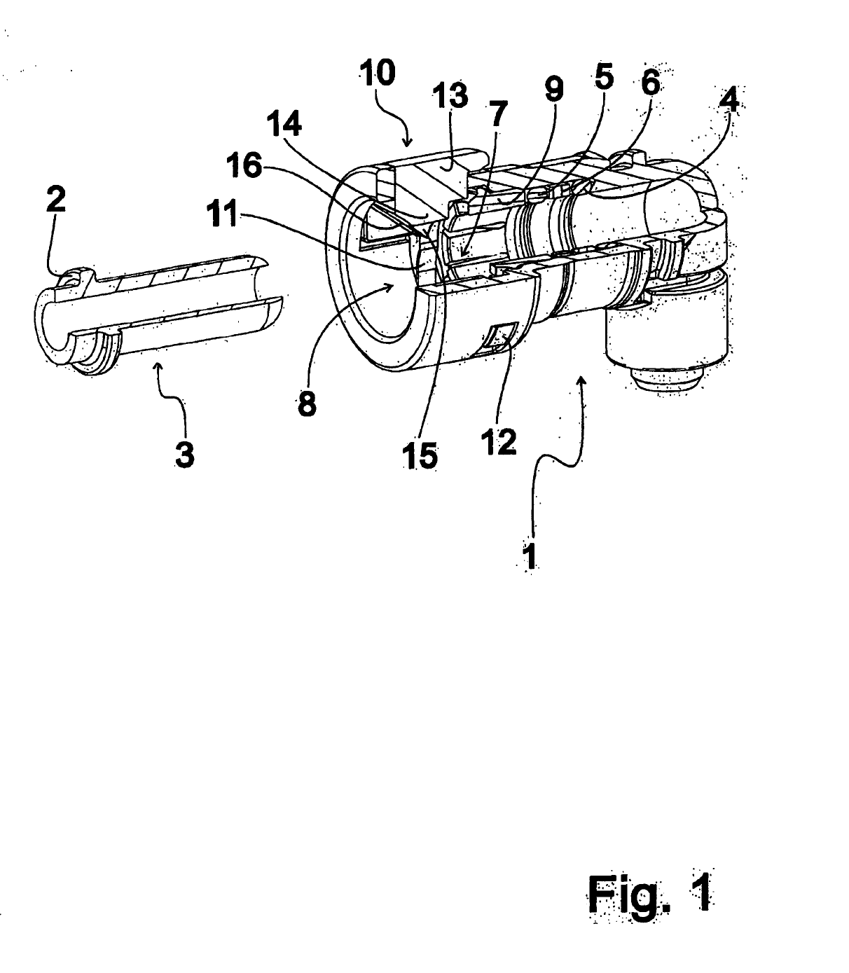

FIG. 1 is a partially cut-away perspective view of an exemplary embodiment of an inventive coupling. The coupling of FIG. 1 comprises a receiving part 1, which can be connected by an end (not illustrated in FIG. 1) to a line of a fluid conducting system. To sealingly connect the inventive coupling to an insert 3 formed with a retaining ring 2, a first sealing ring 4, a second sealing ring 5 and an intermediate ring 6 disposed between sealing rings 4, 5 are provided in a receiving space 7 of receiving part 1. A spacer ring 9 disposed adjacent the face of second sealing ring 5 that is oriented toward the insertion end 8 serves to hold sealing rings 4, 5 and intermediate ring 6 between the side of receiving space 7 facing away from insertion end 8 and a locking element 10 of the inventive coupling.

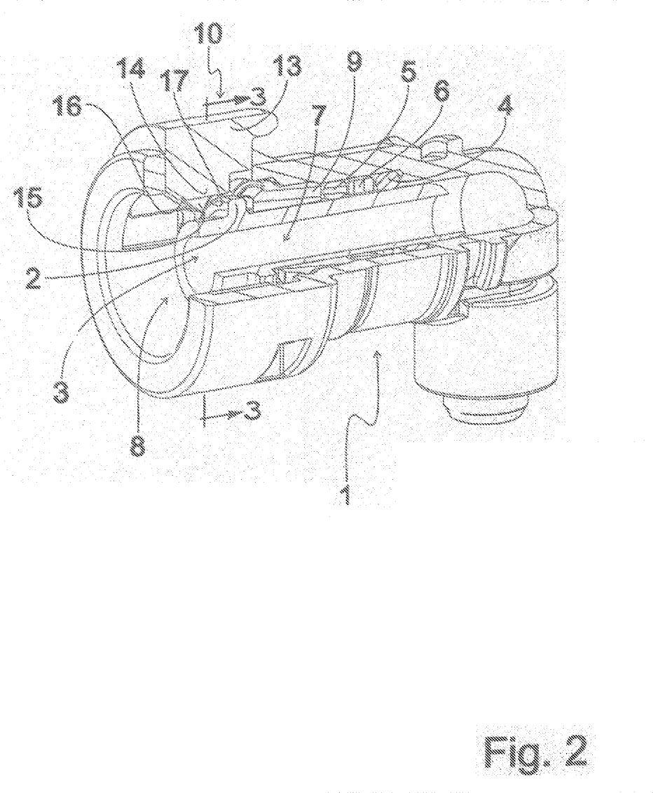

Locking element 10 is displaceable in receiving part 1 between a pushed-in position, shown in FIG. 1, and a raised position shown in FIG. 2, and comprises a first arm 11 and a second arm 12, which are disposed opposite each other and project by an inner portion into receiving space 7. Also formed on a transverse portion 13 extending between arms 11, 12 is a retaining portion 14, which, as explained more thoroughly hereinbelow, engages behind retaining ring 2 when insert 3 is properly inserted, locking element 10 being in a fully pushed-in position and insert 3 being in the properly inserted position. It can also be seen from FIG. 1 that formed on locking element 10 is a projection 15 of a prelock assembly 30, which projection 15 extends into receiving space 7 and comprises a lifting bevel 16 that slopes radially upward and outward in the direction of insertion end 8, oppositely to an insertion direction of insert 3.

FIG. 2 is a partially cut-away perspective view of the exemplary embodiment according to FIG. 1, with insert 3 inserted in the inventive coupling and locking element 10 in a prelocked position which it assumes by way of the raised position. The prelocked position is attained by the fact that during the insertion process, retaining ring 2, on butting against lifting bevel 16, which extends radially inward in the insertion direction, moves locking element 10 radially outward perpendicularly to the insertion direction into a raised position until retaining ring 2 has moved past projection 15 and locking element 10 is in the prelocked position. It can also be seen from FIG. 2 that projection 15 has on its face confronting lifting bevel 16, which is its rear face as viewed in the direction of insertion of insert 3, a driving-in bevel 17 that extends radially upward and outward in the insertion direction.

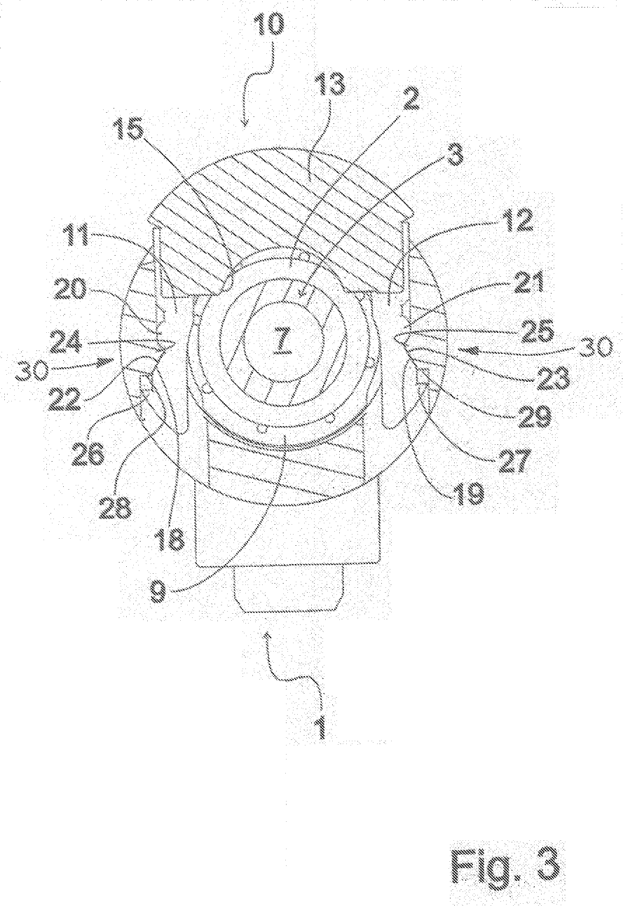

FIG. 3 shows the exemplary embodiment of FIG. 1 in the arrangement illustrated in FIG. 2, in a cross section taken in the region of projection 15 of the prelock assembly 30, looking at the—from the standpoint of the direction of insertion—rear portion of the receiving space 7. It can be seen from FIG. 3 that in the prelocked position, projection 15 engages behind retaining ring 2 and insert 3 is thereby protected in the prelocked position against inadvertently being pulled out of receiving part 1.

It is also apparent from FIG. 3 that each of arms 11, 12 is provided on its radially outer face with a pullback bevel 18, 19 of a pullback assembly 30 of and with a click-stop projection 20, 21, which cooperate with counterbevels 22, 23 of the pullback assembly 30 that are formed on receiving part 1 and are each disposed opposite an assigned pullback bevel 18, 19, or with snap-in projections 24, 25 of the pullback assembly that are formed on receiving part 1, to counteractively maintain locking element 10 in the prelocked position by generating, on the one hand, a force counteracting an extracting force acting to shift locking element 10 from the prelocked position into the raised position, and on the other hand, a radially inward force acting to shift the locking element from the prelocked position into the pushed-in position.

Also formed on each arm 11, 12 is a radially outwardly projecting locking nose 26, 27, which in the prelocked position illustrated in FIG. 3 is disposed at some distance from locking shoulders 28, 29 formed on receiving part 1. When locking element 10 is in the fully raised position, locking noses 26, 27 butt against locking shoulders 28, 29 and prevent locking element 10 against being detached from receiving part 1 when insert 3 is removed from receiving part 1 as a result of the application of forces that do not act radially inwardly on arms 11, 12, in order to deliberately remove locking element 10 from receiving part 1.

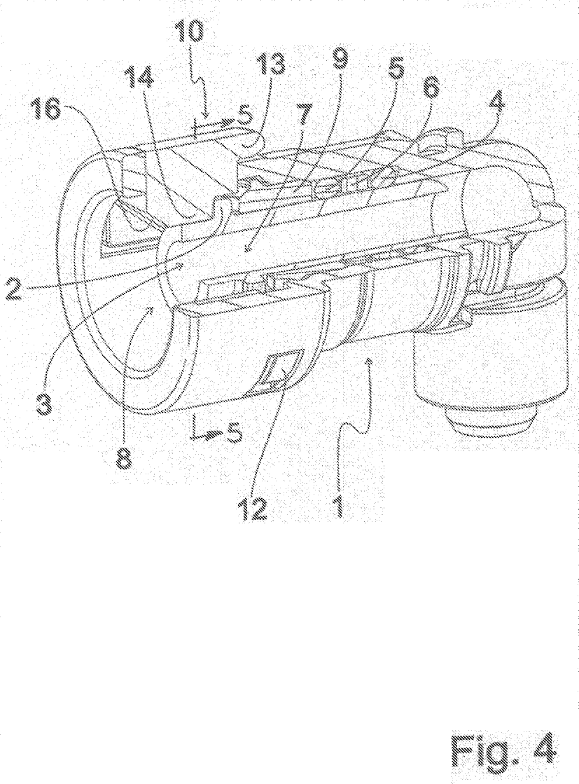

FIG. 4 is a partially cut-away perspective view of the exemplary embodiment according to FIG. 1 with an insert 3 properly inserted in receiving part 1 to sealingly connect the inventive coupling and insert 3, and with locking element 10 in the pushed-in position. When locking element 10 is shifted from the prelocked position into the pushed-in position, insert 3 is driven by the action of drive-in bevels 17 (not visible in the representation of FIG. 4) on retaining ring 2 in the insertion direction into receiving space 3 until retaining portion 14 engages behind retaining ring 2.

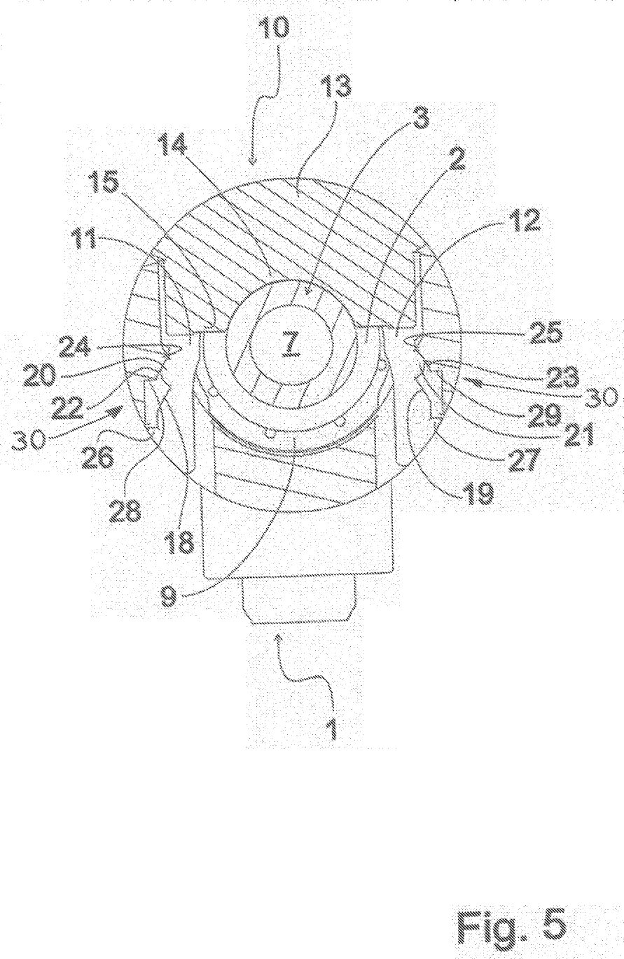

FIG. 5 is a cross section of the exemplary embodiment according to FIG. 1 in the arrangement shown in FIG. 4. It can be seen from FIG. 5 that, compared to the arrangement depicted in FIG. 3, the click-stop projections 20, 21 formed on locking element 10 are now on the other side of snap-in projections 24, 25 in the insertion direction of locking element 10, and protect locking element 10 against inadvertently being shifted from the pushed-in position into the prelocked position.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-4. (canceled)

5. A conduit coupling comprising:
a hollow receiver, said receiver including a receiving space;
an insert adapted to be sealingly and lockingly received into said receiving space, said insert including a retaining ring, said insert movable in an insertion direction into said receiving space; and
said receiver having a locking element adapted to be moved into said receiving space, said locking element perpendicularly movable relative to said insertion direction into a raised position, a pushed-in position, and a prelocked position, said prelocked position being intermediate said pushed-in and said raised positions, said locking element having a first beveled surface adapted to cooperate with said retaining ring to move said locking element from said pushed-in position to said raised position when said insert is initially inserted into a first insertion position in said receiver, said receiver further including a prelock assembly and a pullback assembly which are adapted to cooperate with said retaining ring when said insert is inserted further into said receiver beyond said first insertion position into a second insertion position wherein said retaining ring has moved out of contact with said beveled surface, said prelock assembly preventing said retaining ring and said insert from being pulled out of said receiver when said insert has moved into said second position and said pullback assembly substantially simultaneously moving said locking element into said prelocked position.

6. The coupling of claim 5 wherein said prelock assembly comprises a projection which extends into said receiving space, said beveled surface located on said projection.

7. The coupling of claim 5 wherein said pullback assembly comprises a second beveled surface disposed on said locking element and a third beveled surface disposed on said receiver, said second and third beveled surfaces cooperating to generate a force in a direction opposite to the direction of movement of said locking element from said prelocked position to said raised position.

8. The coupling according to claim 1 wherein said locking element includes a click-stop projection and said receiver includes a snap-in projection, said click-stop projection located adjacent to and on one side of said snap-in projection in said pushed-in position and located adjacent to and on another side of said snap-in projection in said prelock position.
